(19) United States
(12) Patent Application Publication
(10) Pub. No.: US 2010/0070852 A1
(43) Pub. Date: Mar. 18, 2010

(54) Method for Transforming the Source Documents to Corresponding Web Pages

(76) Inventor: Lipeng Li, Henan Province (CN)

Correspondence Address: Sunstein Kann Murphy & Timbers LLP, 125 SUMMER STREET, BOSTON, MA, 02110-1618, US

(21) Appl. No.: 12/093,821

(22) PCT Filed: Dec. 1, 2005
(86) PCT No.: PCT/CN05/02066

§ 371 Date: Oct. 6, 2009

(30) Foreign Application Priority Data
Nov. 15, 2005 (CN) 200510123206.4

(51) Int. Cl. G06F 17/00

(52) U.S. Cl. 715/239; 715/234

(57) ABSTRACT

The invention has disclosed a method for transforming interactive source documents organized in a hierarchy of nested cells to web pages. The method includes: directly mapping the elements of static cells in source documents to web pages so as to enable the transformation of the elements of static cells in source documents to web page elements; selecting the dynamic cells which are to be transformed from the source documents; adding the cell level tags or comments for the selected dynamic cells, and then adding the element level tags or comments for the selected dynamic cells, so as to construct the mapping relationship between the elements of dynamic cells and the corresponding elements of web pages; transforming the elements of dynamic cells to corresponding elements of web pages according to the constructed mapping relationship. By the two-layer-tagging process which is to add cell level tags and cell element level tags to the dynamic cells, the invention can further differentiate the elements of dynamic cells in source documents and construct the mapping relationship between the dynamic elements in source documents and corresponding elements of targeted web pages thus avoid the trouble of writing codes by professionals.

### TECHNOLOGY FIELD

The invention is related to a transformation method for notebook files, especially related to a method for transforming source documents to corresponding webMathematica web pages, a method for transforming Mathematica notebook source documents to corresponding webMathematica web pages and a method to construct the overall mapping relationship between the elements in source documents which are interactive and organized in a hierarchy of nested cells and corresponding web pages.

### BACKGROUND ART

Mathematica is a popular software platform in science and engineering field with advanced support for symbolic, numeric, and graphical computation. Mathematica also includes a functional style language which can be used in prototyping, interface environment and many research and application fields.

webMathematica is a newly developed technology based on Java Servlet and JavaServerPages (JSP) which provides full access to Mathematica online to a web browser. It behaves as the middle layer between web browsers and Mathematica computing kernels in the back end of the web servers.

The Mathematica users who wish to develop webMathematica applications must know how to write JSP pages by using the MathematicaServerPages(MSP) taglib extension. Since the complicated structure of webMathematica web page as tiers pile up of HTML/JSP/MSP, learning these technologies is costly and time consuming. The Mathematica users and programmers prefer to have a tool which can translate their notebooks into JSP\&MSP pages with similar layout, behavior of computation and function of user interaction.

webMathematica Author is a tool offered by Wolfram Inc. It provides an authoring environment for webMathematica. webMathematica Author also provides some buttons on the palette to give the type of the cell by tags.

The main disadvantages of webMathematica Author is that it needs the user to edit the original notebook to a mixture of Mathematica code, JSP code and MSP code by the combination of handwork programming and the utilization of the buttons that paste webMathematica codes onto the notebook. To edit this notebook, the Mathematica programmer must know the meaning of the JSP and MSP constructs. It requires much hand programming effort when user uses it. The correctness of the finally generated webMathematica code is ensured by the quality of the mixture code edited by the users.

webMathematica Author has already provided a group of cell tags to describe the type or the content feature of notebook cells. The problem is that all of them can only describe the whole cell level features, and the tags provided by webMathematica Author are far away from enough to distinguish all the elements in Mathematica notebooks to construct a unique and over all mapping relationship to the elements in webMathematica files. Even for whole cell level tagging, they are still not enough. Inside the cells, the cell content should be further distinguished to a group of lower level notebook elements such as expressions, variables, options, functions and so on. The names of them are optional in translator. Herein, the present invention only emphasize that the cell content should be differentiated into a group of different types of lower level elements. Anyway, when a Mathematica notebook is required to be converted to webMathematica files, the cell content has to be dealt with. If the cell content can not be directly and automatically converted to webMathematica format constructs, this part of the work has to be done by hand programming. Though webMathematica Author provided some buttons to paste some webMathematica code snippets, the snippets are not complete, and still need the user to fill in some parameters by hand. That is the internal reason why it must require the handwork programming of the users to be involved in the translation procedure so that everything inside can be specified enough for the translation.

webMathematica Author also uses pattern matching functions to do traversing and converting. But its pattern matching functions don't go into the inside of the cell content, they only find the type information of the whole cell by tags and deal with the cell as a whole. Because it can not transform the cell elements level components such as expressions, variables, options and so on, it asks the user to fill in the corresponding webMathematica codes by hand and paste some webMathematica code snippets by some buttons it provided on its palette. After the user fills in all the necessary webMathematica codes, it starts to convert the static Mathematica cells such as title cells, section cells, text cells to static HTML contents and finally exports the webMathematica files with the user input webMathematica code and translated static HTML content. This webMathematica file generation procedure is not automatic.

### INVENTION CONTENTS

One purpose of the invention is to provide a method for transforming source documents which are interactive and organized in a hierarchy of nested cells to web pages, so as to reduce the work load and complexity of the people who is involved in the transformation work.

Another purpose of the invention is to provide a method for transforming Mathematica notebook source document to webMathematica pages so as to solve the problem that it is necessary to write the corresponding webMathematica codes by handwork of professional.

The further another purpose of the invention is to provide a method to construct the overall mapping between the elements of the source documents which are interactive and organized in a hierarchy of nested cells and the targeted web pages, so as to reduce the work load and complexity of the people who is involved in the transformation.

According to the first aspect of this invention, it is provided with a method for transforming source documents which are interactive and organized in a hierarchy of nested cells to web pages, including:

directly mapping the elements of static cells in source documents to web pages so as to enable the is transformation of the elements of static cells in source documents to web page elements;

selecting the dynamic cells which are to be transformed from the source documents;

adding the cell level tags or comments for the selected dynamic cells, and then adding the element level tags or comments for the selected dynamic cells, so as to construct the mapping relationship between the elements of dynamic cells and the corresponding elements of web pages; and

transforming the elements of dynamic cells to corresponding elements of web pages according to the constructed mapping relationship. In this aspect, by the two layers of tagging with cell level tags and cell elements level tags to the dynamic cells, the elements of the dynamic cells in the source documents are further differentiated, which enables the construction of one to one mapping relationship from the dynamic elements in source documents to the corresponding elements in targeted web pages and reduced the trouble of writing source codes by professionals.

Wherein adding tags or comments of cell element level to said dynamic cells includes: adding one or more tags or comments before or after the said dynamic cells, and copying the selected elements of the said dynamic cells in the tags or comments. Because adding cell element level tags or comment to the above dynamic cells is the copy of the elements in the dynamic cells, it is possible to enable the non-professionals to easily transform the source documents to the targeted web pages.

Wherein adding tags or comments of the dynamic cell level before or after the tags or comments which copied the elements of dynamic cells in order to differentiate the type of the dynamic cells.

Wherein the tags or comments of cell level for the dynamic cells include: tags or comments of the dynamic cells for 3D graphic, tags or comments of the dynamic cells for 2D graphic, tags or comments of the dynamic cells for the value replacement, tags or comments of the dynamic cells for evaluation.

Wherein the dynamic cell element level tags or comments is composed of field representing the type of the elements in the selected dynamic cells, the field representing the content of the elements in the selected dynamic cells, and the segmentation string between the fields;

Wherein the cell element level tags or comments of the dynamic cells are made up of two fields or more fields which are segmented by the segmentation strings.

Wherein the cell element level tags or comments of the dynamic cells include: tags or comments for the selected expressions, tags or comments for the selected variables, tags or comments for the is selected function names, tags or comments for the selected options, tags or comments for the selected inputs, and so on;

Wherein one segmented field segmented by the segmentation string represents that the selected element in the dynamic cell is expression type, and the other segmented field represents the content of the expression element in the selected dynamic cell elements in the tags or comments for the selected expression.

Wherein the needed dynamic cell element level tags or comments for the processing of dynamic cells in computing type include some or all of the following tags or comments: the tags or comments for the selected functions, the tags or comments for the selected expression, the tags or comments for the selected variables;

Wherein the needed dynamic cell element level tags or comments for the processing of dynamic cells in 2D graphic type include some or all of the following tags or comments: the tags or comments for the selected expression, the tags or comments for the selected variables, the tags or comments for the selected options;

Wherein the needed dynamic cell element level tags for the processing of dynamic cells in 3D graphic type include some or all of the following tags or comments: the tags or comments for the selected expression, the tags or comments for the selected variables, the tags or comments for the selected options;

Wherein the needed dynamic cell element level tags or comments for the processing of dynamic cells in value replacement type include some or all of the following tags or comments: the tags or comments for the selected inputs.

Wherein the steps in the transformation of the elements of the dynamic cells to the corresponding elements in the web pages includes: calling the pattern matching functions to detect the cell level tags or comments and the cell element level tags or comments of the dynamic cells, and calling the corresponding pattern processing functions to transform the elements of the dynamic cells to the corresponding elements of web pages according to the detected vary combination pattern of the tags or comments.

Wherein the steps of calling pattern matching functions to detect the tags or comments of dynamic cells include:

finding the field representing the type of the dynamic cells by the detection of the cell level tags or comments;

finding the field representing the type of the copied element and the field representing the content of the element by detecting the cell element level tags and comments;

extracting the elements of the dynamic cell in the source document and the type information of the elements from the field representing the type of the dynamic cells and the fields representing the type and content of the copied elements in the cell level tags or comments and cell element level tags or comments;

calling the corresponding processing functions to perform the transformation and translations to the dynamic cells.

According to the second aspect of the invention, it is provided with a method for transforming Mathematica notebook source document to webMathematica pages, including:

that the translator directly map the elements of the static cells in the source documents to the elements of the targeted web pages according to the mapping relationship between the static elements in the source documents and the elements in the web pages; and

the method further including the following steps:

selecting a dynamic cell which is to be transformed from the source Mathematica Notebook;

adding cell level tags for the type of the selected dynamic cell by the selection on the control panel of the translator;

for the dynamic cells that need to be processed at the cell element level, add the cell element level tags by the control panel to construct the mapping relationship between the elements of the dynamic cells and the corresponding elements of the web pages, in which Adding cell element level tags to the dynamic cells includes: adding a tag before or after the dynamic cell and copying the selected cell element of the dynamic cell in the tag;

the translator transforming the elements of the dynamic cells to corresponding elements of targeted web pages by calling the transformation functions matched with the patterns according to the vary combinations of the cell level tags and the cell element level tags.

is In this aspect, by the two layers tagging process to the dynamic cell with cell level tag and cell element level tags, the method further differentiates the elements in the dynamic cells of the source documents, enables the construction of one to one mapping relationship between the dynamic elements in the source documents and the elements in the targeted web pages, reduces the trouble of writing codes by professionals by the copy of elements in the dynamic cells for the adding of cell element level tags or comments to the dynamic cells, and helps the non-professionals to easily transform the source documents to the targeted web pages.

Wherein the steps of transformation of elements in the dynamic cells to the targeted web page elements include: the translator searching for the matched transformation functions by calling the pattern matching function to detect the cell level tags and the cell element level tags of the dynamic cell, then using the found matched transformation functions to transform the elements of the dynamic cells to the corresponding elements of targeted web pages.

According to the third aspect of this invention, it is provided with a method for constructing the overall mapping relationship between the elements of source documents which are interactive and organized in a hierarchy of nested cells and the elements of targeted web pages, including:

constructing the definite mapping relationship between every element in static cells of source documents and every corresponding element in targeted web pages in the area of mapping table;

selecting the dynamic cells that need to be mapped from the source documents;

adding the cell level tags which represent the type information to the selected dynamic cells, then adding the cell element level tags to the selected dynamic cells, wherein the cell element level tags include the copy of the selected element of the dynamic cell;

constructing the area which is related with the cell level tags in the mapping table, then constructing the definite mapping relationship between the every element copy in the cell element level tags and every corresponding element in the targeted web pages in the area, so as to construct the definite mapping relationship between every element of dynamic cells and every corresponding element of targeted web pages.

In this aspect, by the two-layer tagging process of adding cell level tag and cell element level tags to the dynamic cells, the method further differentiates the elements of the dynamic cells in the source documents, and enables the construction of one to one mapping relationship between the dynamic elements of source documents and the corresponding elements of targeted web pages, so as to easily realize the overall mapping between the elements of source document which are interactive and organized in a hierarchy of nested cells and the elements in the targeted web pages.

Wherein the construction of definite mapping relationship is realized by writing the static cell element and dynamic cell elements as original in the mapping table.

Wherein the source document is Mathematica notebook document, and the targeted web page is webMathematica files.

Hereinafter, the invention will be described in detail with reference to accompanying figures.

### DESCRIPTION OF FIGURES

FIG. 1 showed an example of Mathematica notebook;

FIG. 2 showed the typical structure of a webMathematica file;

FIG. 3 is the processing flow of the source Mathematica notebook;

FIG. 4 showed the human involved work flow of the translator;

FIG. 5 is the underlying principle of the tagging mechanism;

FIG. 6 is an example of the Mathematica notebook that needs to be transformed

FIG. 7 is the palette buttons by which to differentiate the component at cell element level;

FIG. 8 showed an example of a tag for cell element level;

FIG. 9 showed another example of a tag for cell element level;

FIG. 10 showed a Mathematica notebook file tagged by the tagging mechanism of the translator;

FIG. 11 showed the upper part of the webMathematica file transformed from the Mathematica notebook showed in FIG. 10;

FIG. 12 showed the below part of the webMathematica file transformed from the Mathematica notebook showed in FIG. 10;

FIG. 13 showed the sketch map of the traversal work;

FIG. 14 showed the sketch map of the transformation work of this invention;

FIG. 15 showed the compare of the work style between this invention and webMathematicaAuthor;

FIG. 16 showed the generated webMathematica page.

### BEST MODE OF CARRYING OUT THE INVENTION

Although the following explanation is described with the aim at Mathematica notebook document, this invention is also applicable to the source documents which are interactive and organized in the hierarchy of nested cells.

In an actual embodiment of the method in the invention for transforming the Mathematica notebook documents to webMathematica web pages, a Mathematica translator alike convertor is used, and the static cell elements in the source Mathematica notebook documents are directly mapped to the static elements in webMathematica files according to the underlying mapping relationship between the static elements of Mathematica notebook documents and the elements in webMathematica files. Then select the dynamic cells that to be transformed in the source Mathematica notebook document and add the cell level tags which are to mark the cell type to the selected dynamic cells by the selection of the translator palette (control panel). This is the first round of tagging process to extract some elements from the dynamic cells of the source Mathematica notebook documents. But the extracted elements by this round process are generally less than webMathematica elements thus it is not able to construct the overall mapping relationship to the elements of the webMathematica pages. It is necessary to perform the following process of adding cell elements level tags to the content of dynamic cells.

In other words, it is necessary to add the cell element level tags with the control panel to the dynamic cells that need to be processed at the cell element level. This is the second round tagging process to extract all the elements from the content of the dynamic cells in the Mathematica notebook documents, so as to construct the one to one mapping relationship between the dynamic elements and the corresponding web page elements.

Then use the translator to do the traversal on the cell level tags and the cell element level tags, and call the matched pattern matching functions to transform the elements of dynamic cells to the corresponding elements of webMathematica pages according to the detected vary combination forms of the cell tags.

The skilled person in the art can find that the main feature of the invention is to add the cell element level tags to the dynamic cells based on the added cell level tags to the dynamic cells from the above implementation example. By this way, the overall mapping between the elements of Mathematica notebook documents and the elements of the webMathematica pages is realized.

Furthermore, for the common users conveniently adding the cell element level tags, the invention completes the adding of cell element level tags by copying the selected elements from the dynamic cells in the tags or comments so as to not only greatly reduce the work load but also avoid the error made in adding tags by writing.

Because the Mathematica notebooks are interactive and organized in a hierarchy of nested cells, the transformation method and mapping method based on adding cell element level tags to the dynamic cells in the invention are applicable to the documents which are interactive and organized in a hierarchy of nested cells. Hereinafter, the invention will be described in detailed with reference to the accompanying figures.

Mathematica notebooks and webMathematica files are the input and output of the translator. The translator of the invention works in two stages. The first stage is tagging the notebook elements with the special tags added by using palette buttons and the mouse or cursor. The method of tagging will be explained later. The second stage is translating the annotated notebooks into webMathematica pages.

In order to understand how translator works easily, a brief description of the input and output is given.

### <Structure of Mathematica Notebooks>

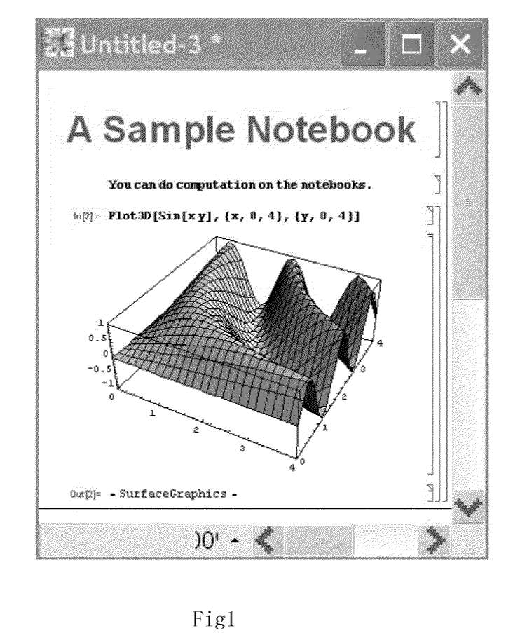

A Mathematica notebook is organized in a hierarchy of nested cells. Cells can be of different types such as text cells, input cells for symbolic computing or graphic display and so on. FIG. 1 is a typical Mathematica notebook which has cells for static content such as Title and Text cells and also has cells for dynamic content such as Output cells and Graphics cells.

Cells of the same type can be further distinguished by using the tagging mechanism of Mathematica. The general structure of a cell is:

Cell[content,style, . . . , CellTags→tagvalue]

wherein content is the content of the cell, style is a built-in Mathematica style for cells, and tagvalue is the tag of the cell. The cell tag feature will be used in the translator in the invention.
<Structure of webMathematica Files>

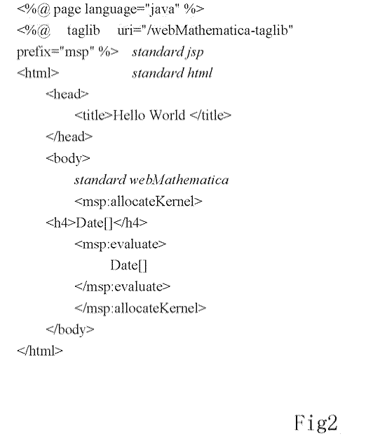

A webMathematica file is a JSP file enhanced with MSP tags which describes the interaction between Mathematica and a standard web browser. FIG. 2 illustrates the typical structure of a webMathematica file.

This page uses standard HTML tags as well as special webMathematica tags which have the form <msp:tag>. The <msp:allocate> tag causes a Mathematica kernel to be allocated for computation tasks. The contents of the <msp:evaluate> tags are sent to Mathematica for computation with the result inserted into the final page. The </msp:allocate> tag releases the Mathematica kernel to wait for next computation task. webMathematica file's nest tag hierarchy can also be viewed as in tree structure.

### <The Architecture and Work Flow of the Translator in the Invention>

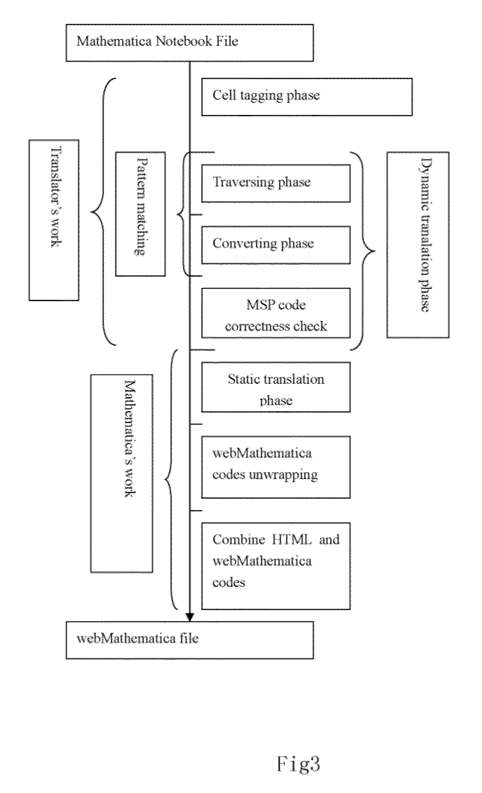

A tool is developed in the invention to directly translate the Mathematica notebooks to webMathematica pages so that the user of this tool can put the translated webMathematica web pages directly onto the directory of web server which has a back end Mathematica computing support. The working procedure of this tool consists of the cell annotation phase and the dynamic translating phase. The whole translation work is separated into dynamic translation for the computing cells that should be translated into dynamic and interactive webMathematica content and static translation for the static cells that should be translated into static HTML content. The static translation is beyond the work of translator in the invention. The general dynamic translating behavior is pattern matching. A pattern matching function for a specific translation has two steps, the first is the traversing phase to check the conditions, and the second is the converting phase to launch the processing function to do transformation. The correctness of the generated webMathematica code will be checked after the translation. The correctness checking is the work of translator in the invention after the transformation. From FIG. 3 we can see how the original Mathematica notebook is processed and the position of the translator in the invention in the whole transformation procedure. In order to establish the full mapping of Mathematica elements to webMathematica elements, the invention developed a cell annotation mechanism to add extra information to the Mathematica notebook elements such as elements of cells, expressions, functions, variables, and options. The invention developed a palette (control panel) as GUI(Graphical User Interface). The cell annotation mechanism is realized by using the buttons on the palette. Palette buttons call their respective button functions to give the notebook elements tags to make them get more information to describe themselves. The function of the tags is similar to put the cells with annotation having semantic, and extracts the cells out to form matching pair of data and data type. The user uses the palette buttons and mouse or key board to make cell annotation and webMathematica file exportation.

The translating phase, is a big functional programming style pattern matching. The condition check steps and corresponding processing functions are combined together as a pair to describe a translating behavior. For the convenience to describe the pattern matching in the programs, the invention calls all the checking work before converting as the abstract traversing phase. The traversing phase only traverses the Mathematica notebooks to recognize the structures and elements.

The converting phase transforms the elements extracted by traversing the notebooks into corresponding elements of webMathematica files by transformation rules.

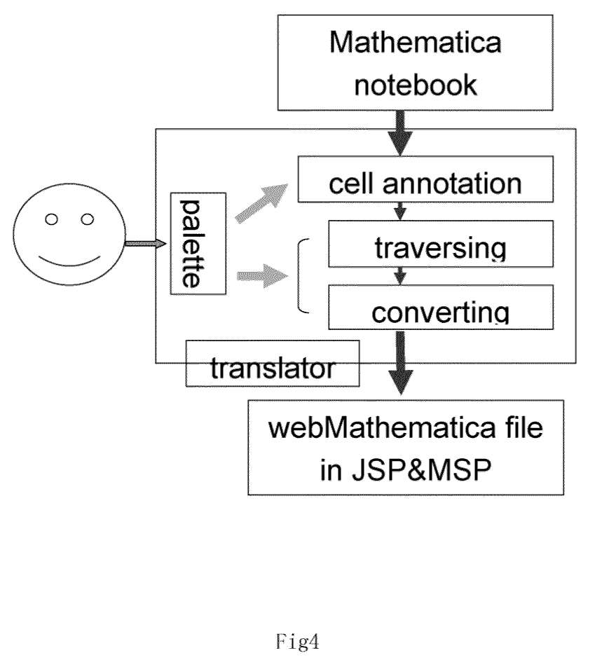

FIG. 4 illustrates the process in the case of human involved work flow of the translator.

### <The Cell-Annotation Phase>

The inventor found that in Mathematica notebooks, the elements are far away from enough to describe themselves on web because the cell types of Mathematica are insufficient to classify the dynamic behavior of webMathematica. They must have extra information added to make a unique mapping of notebook elements to webMathematica elements available. Mathematica notebook has a convenient structure to give further information which is CellTag. So the invention uses Cell Tags to tag every cell and the cell contents if the translator needs to further deal with the content components of one cell.

The underlying principle of adding tags is following:

To transform a set A to set B, we need to define mapping rules. Before we define the mapping rules, we need to learn who is mapped to whom in the elements. If the elements in A are less than in B, one element in A may map to multiple elements in B. To give a unique mapping, we have to give extra information to the elements in A to further distinguish them. This could be called tagging. After the first round tagging, some tagged elements in A may be still ambiguous to be mapped to the elements in B. We can make a second round tagging for them to make them distinguished more clearly and make the information (elements) items in A further increased. Only when the total information items in A have the same amount as in B, We can give them a one by one full mapping. FIG. 5 shows the underlying principle of the tagging mechanism.

In general, there is one to one mapping relationship between the static cell elements of Mathematica notebook documents (source documents) and the elements of webMathematica files (targeted web pages). But there is no one to one mapping relationship between the elements of the dynamic cells and the elements of the webMathematica pages. One feature of the invention is to extract the elements in the nested dynamic cells by adding tags to the elements in the dynamic cells, so as to realize the one to one relationship between the elements of the dynamic cells and the webMathematica pages, thus implement the overall mapping. The method of constructing overall mapping in the invention includes the following steps:

Constructing the definite mapping relationship between every element in static cells and every corresponding element in targeted web pages in the area of mapping table;

Selecting the dynamic cells that need to be mapped from the source documents;

Adding the cell level tags which represent the type information to the selected dynamic cells, then adding the cell element level tags to the selected dynamic cells, wherein the cell element level tags include the copy of the selected element of the dynamic cell;

Constructing the area which is related with the cell level tags in the mapping table and then constructing the definite mapping relationship between the every element copy in the cell element level tags and every corresponding element in the targeted web pages in the area, so as to construct the definite mapping relationship between every element of dynamic cells and every corresponding element of targeted web pages.

The cell annotation mechanism and the transformation rules are contribution of the invention for the translation of Mathematica to webMathematica. The cell annotation mechanism is the most important part in the whole tool. It distinguishes the elements of the notebook so that the traversing phase can check them out and call the corresponding transformation rules to convert them.

The user uses the palette to tag the cells of the Mathematica notebook. The palette includes a group of buttons to give tags to the cells. There are tags to describe the whole cell, such as static cell to tell the converter to just copy the contents of the cell, hide cell to tell the converter to import some functions from outside packages and only show the computing result on the web pages, some tags to tell information about the expressions, variables, options to map to the dynamic updating and interactive computing constructs of the webMathematica pages.

With the new cell tag group, the Mathematica programmers only need to know Mathematica and the usage of the palette buttons which correspond to the tags of variant meanings. The cells will be translated into specialized webMathematica code (e.g., for dynamic 3D graphic display, input, evaluation of submitting buttons, tables, etc.). This is in contrast to webMathematica Author, which will generate a Mathematica notebook containing syntactic constructs of JSP and MSP after much coding work of the Mathematica programmers.

### <The Cell-Annotation Mechanism>

The cell tags have two levels, one of which is for the cell level. In this level, all the tags are for the types of the cells. They show the purpose or the options of the whole cell. Cell level tags are as following:

| | |
|---|---|
| MSPTag:Visible | MSPTag:Hidden |
| MSPTag:InactiveCell | MSPTag:ActiveCell |
| MSPTag:Live3D | MSPTag:Graphics |
| MSPTag:Compute | MSPTag:ReplaceValue |

The tag types of “Compute” and “ReplaceValue” are added in the invention for cell level tags. The names of the tags are optional. The important thing is to find out the necessary types that need to be differentiated. When the user uses the buttons to give cell level tags, one or several of the above tags will show on the notebook just over the selected cell.

The other level is for the cell elements level in which all the tags are for the type or content of the respective selected elements from the cell content. The cell elements level tags are as following:

Selected Expr:_, Selected Variable:_, Selected Input:_, Selected Fun:_, Selected Option:_ “Selected Expr” represent the type of the selected component of the cell content, “:” is a symbol for the segmentation to segment the tag to two fields, “_” represent the selected content, and because the selected content is not definite, “_” is used to represent the optional selection.

### <The Usage of the Cell Annotation Mechanism>

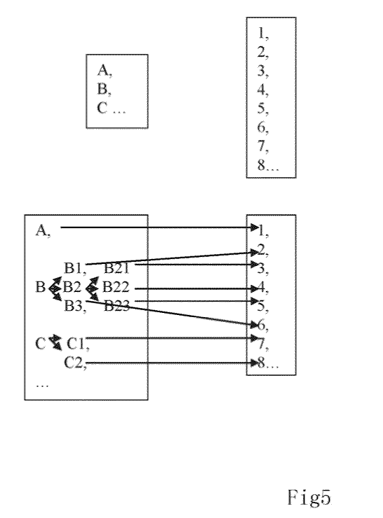

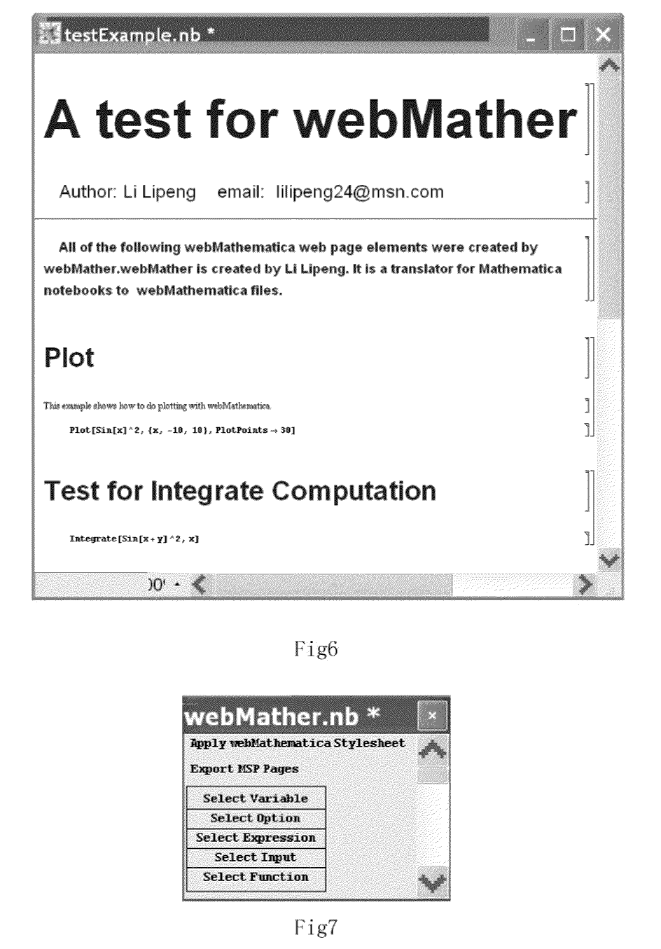

The invention will use an example to explain the cellannotation mechanism and the usage of the mechanism. FIG. 6 shows a Mathematica notebook example for translation.

There are eight cells from upper to lower in the above notebook, each of which is from the bracket at the right end of the notebook. The content of first cell in the above notebook is in “Title” style. The second cell content is in “Subtitile” style. The third cell content is in “Section” style. The fourth, fifth, seventh cell contents are in “Title”, “Text”, “Title” styles respectively. All of these cell contents are static cell contents and need not be annotated. After the translator deals with the dynamic cell contents, they will be translated by Mathematica system functions to HTML contents.

The contents of the sixth and eighth cells are dynamic computing contents. The sixth is for graphics plotting. The eighth is for integrate computation. By predefinition, the graphics plotting content is belonging to “Graphics” type. So it should be given a tag of “MSPTag:Graphics” as the whole cell level annotation by palette buttons. The integrate computation is belonging to “Compute” type. So it should be given a tag of “MSPTag:Compute”.

The cell content of these two cells should be further dealt with. FIG. 7 shows the palette buttons for the differentiation of cell element level components.

The user firstly selects the cell element level component, and then presses the corresponding button on palette, the cell tag will be added just over the selected cell after the button press.

The cell content in the sixth cell is:

Plot[Sin[x]², x, −10, 10,PlotPoints→30]

The user selected “Sin[x]²” as an expression, “x” as a variable, “PlotPoint” as an option, and the cell elements level tags would come out as in FIG. 8.

The generated tags are: Selected Expr: Sin[x]², Selected

Variable: x, Selected Option:PlotPoints

The cell content in the eighth cell is:

Integrate[Sin[x+y]², x],

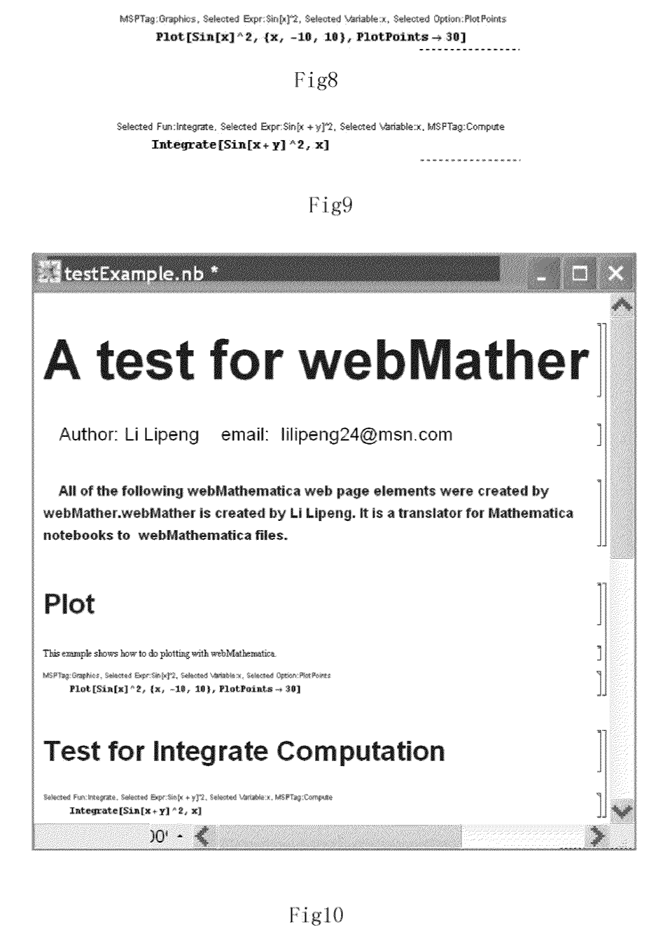

The user selected “Integrate” as an function, “Sin[x+y]̂2” as an expression, “x” as a variable, and the cell elements level tags would come out as in FIG. 9.

In FIG. 9, the generated cell tags for the annotated cell elements in the integrate cell are: Selected Fun:Integrate, Selected Expr: Sin[x+y]², Selected Variable:x, MSPTag:Compute

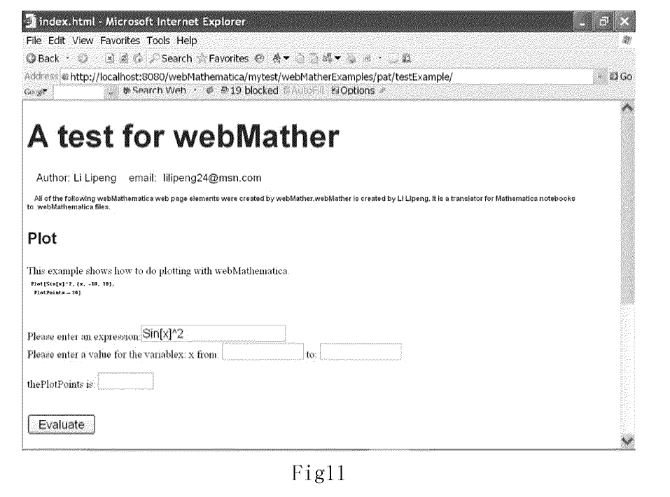

FIG. 10 showed the Mathematica notebook file annotated by the tagging mechanism of the translator.

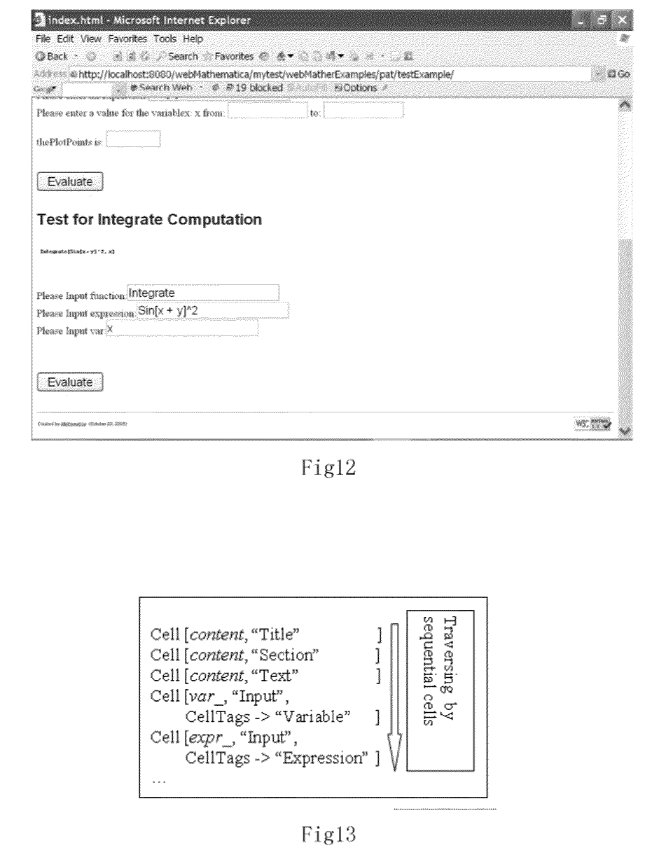

Now the notebook file is already annotated, the user presses the export button, and the webMathematica pages will be generated. The user can put the generated web pages into the directory of the web servers. The generated webMathematica pages will be shown in the FIG. 11 and FIG. 12.

FIG. 11 generated the upper part of the webMathematica page; FIG. 12 generated the low part of the webMathematica page.

### <The Critical Point of the Cell-Annotation Mechanism>

The difference of cell level tags and cell elements level tags is inside the tags. Let's compare them. MSPTag:Compute VS. SelectedExpr:Sin[x]²

Both of them have a static part and a dynamic part. The static part and dynamic part are separated by a colon. According to predefinition, “MSPTag” and “SelectedExpr” are static parts. “MSPTag” shows the type of the tag as a cell level tag. “SelectedExpr” shows the type of the tag as a cell element level tag. “MSPTag” and “SelectedExpr” are both predefined field for the differentiation of the cell tags to be belonging to the cell level or the cell element level.

The dynamic parts are different. “Compute” and “Sin[x]²” are dynamic parts. “Compute” is predefined to show the type of the whole cell. It is fixed. “Sin[x]²” is not predefined or fixed. It is a reflection (copy) of content which the user selected by mouse or keyboard in the cell content.

The selection of content reflection in the tags is the critical reason that this translator can work. Because by this way, the pattern matching functions can not only check out the type information of the whole cell and the type information of the cell elements level cell content components, but also can check out the cell content components from the cell tags. The cell content components are likely grouped and further copied, then stored in cell element level cell tags. The pattern matching functions can find all the notebook elements and the type of the elements. The transformation to webMathematica elements can be achieved by a table of transformation rules.

In the internal programs, there is a variable delegating the user's selection content. There is a mechanism to get, transmit, communicate, and exchange the value of the variable. The cell annotation mechanism is implemented in the following work flow:
1. Selecting a cell from the source Mathematica Notebook
2. Using buttons to give cell tags for the type of the whole cell
3. Using mouse or keyboard to select components from the cell if elements of the cell content need to be further dealt with specifically in detail
4. Generating a variable to delegate the selected content
5. Combining the string delegating the predefined types for the selected cell content part and the string variable delegating the selected component content, while separating the two parts by some symbol or strings.
6. Generating the cell element level cell tags
7. Giving tags to other components of the cell content or other cells

### <The Traversing Phase>

In this stage, the translator analyzes a Mathematica notebook by traversing the notebook's hierarchical nested cells.

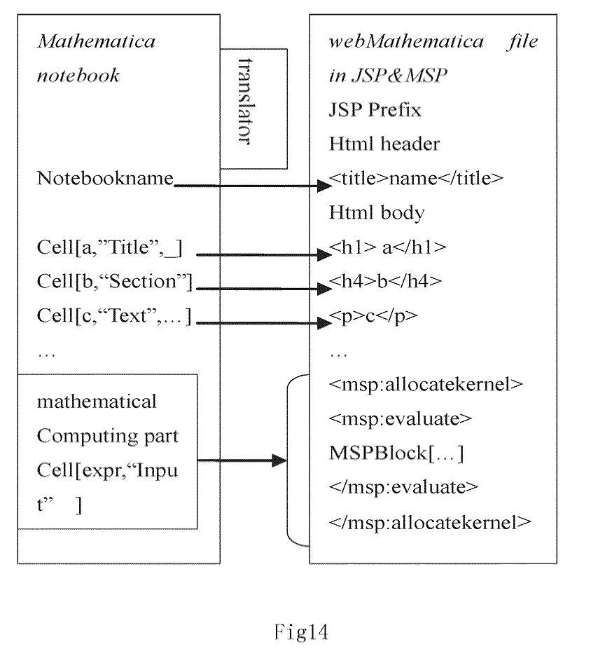

In order to recognize Mathematica notebook's variant elements that indicate different corresponding functionality of webMathematica code phrases, the invention proposed a Tagged-Cell traversing mechanism. The traversing work is done as in FIG. 13:

After the tagging procedure with palette buttons to the notebook elements of cells and expressions, the user presses the Export button. That button will internally firstly launch the translator to do traversing. Every tag checked out will trigger a transformation event in traversing procedure. The traversing work will report the following series of cells to pattern matching functions of translator:
1. Started traversing the notebook
2. Judge finding the static cells if a cell has no cell tag by detection of the cell level tags, no action is performed to it temporarily, and leave it to the transformation functions of the Mathematica platform to process;
3. Find the dynamic cells by detection of the field which has predefined meaning and at the to predefined position in the cell level tags, for example, find having “MSPTag:Compute”, wherein “MSPTag” means that this cell is a dynamic cell and will be translated to be MSP phrases;
4. Differentiate the type of all the dynamic cells by detection of the field which has predefined meaning and at the predefined position in the cell level tags, for example, find having “MSPTag:Compute”, wherein “Compute” means that this dynamic cell is in computing type;
5. Find the tags for variables, expressions, options by detection of the field which has predefined meaning and at the predefined position in the cell element level tags, for example, find “SelectedExpr:Sin[x+y]̂2,Selected Variable:x”;
6. Find the predefined type for the selected component of cell content by detection of the static part of the tags for cell element level, for example, “SelectedExpr” means that the type of the selected component in the cell content is expression, and “Selected Variable” means that the type of the selected component in the cell content is variable;
7. Extract the notebook file element from the field of the dynamic part of the tags representing the selected component of the cell content, for example, get the content of the selected expression from “Sin[x+y]̂2, and get the content of the selected variable from “x”;
8. Call the matched processing functions to do the transformation for the whole cell after completing the detection of a dynamic cell;
9. Found other dynamic cell and static cell, and do the detection and extraction jobs for the cells.
10. Finish the traversal on the notebook.

When the translator finds a tag, it differentiates what cell is in the notebook. Every cell checking step (which can also be called pattern matching step) has a corresponding transformation function (where can get the transformation function?) which will transform the tagged cells and elements in the notebook into the corresponding webMathematica page elements. The transformation function is corresponding processing function which is edited according to the working modes combined with extracted notebook elements and tags in various combination cases based on the analysis of notebook structure.

As the translator sequentially encounters each item, it deals with only one cell at a time and not all of them at once, which consumes much less memory than tree parsing and is easier to find the matching pattern for only one cell at one time.

### <The Converting Phase>

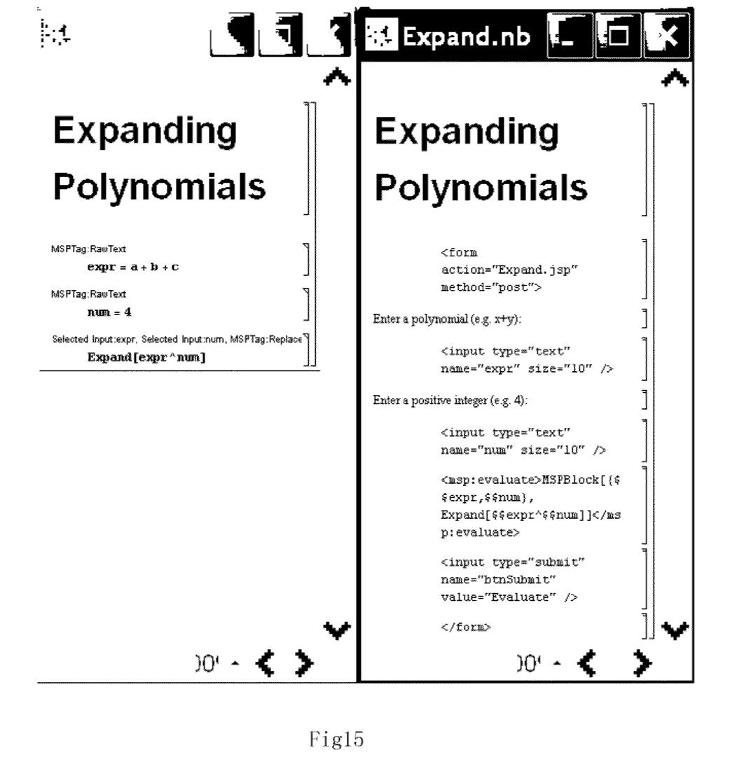

The trees of Mathematica notebooks and webMathematica files have similar structures. This similarity can be described by a mapping between their elements. As shown in FIG. 14, for the static Mathematica notebook elements, they can map to corresponding web elements almost one by one. For the notebook's dynamic computing cells, they may map to a phrase block in webMathematica files which is a combination of html forms, frames, JSP and MSP to delegate Mathematica behavior on web.

From the checked out result by traversing, the translator determines to call the corresponding transformation rules for the respective checked result. When a cell level tag shows that the cell is should be dealt with as a whole without the special processing of the cell content, the translator call the transformation rules to deal with the cell as a whole. When a cell level tag is MSPTag:Live3D, MSPTag:Graphics, MSPTag:ReplaceValue or MSPTag:Compute, the predefined meaning for the tags indicates that the cell needs to be further treated for the user selected components of the cell content. From the predefined types of the selected cell content components checked out from the static part of the cell elements level tags and the notebook elements extracted from the string of dynamic part of tags for selected cell content components, the translator determines to call the corresponding rules to transform the special selected cell content components respectively.

The transformation work is not completed in one step. It firstly generates an intermediate notebook object in memory which would be cleared away from the memory after transformed to webMathematica files or failing to be transformed and contains many “JSP” style cells according to webMathematica style sheet. All the webMathematica (HTML/JSP/MSP mixture) codes are wrapped in the content parts of the “JSP” style cells, for example: Cell[“<msp:allocateKernel>\n”, “JSP”].

The “JSP” style cells translated from the respective selected cell content components of the same cell will be rearranged and combined together as a group to describe the webMathematica behavior of the Mathematica cell content.

The translation work for the tagged cell is dynamic translation based on this translator.

The webMathematica code in the “JSP” style Cells will be unwrapped by the Export function called by the button. The unwrapping middle procedure is achieved by the function of Mathematica platform matching the technology of the webMathematica style sheet.

The static notebook cells that have no cell tags will be translated directly to the corresponding HTML codes after the translator finishes translating the tagged cells.

The translation work for the static notebook cells that have no cell tags is static translation. This is called by the translator but done by the Mathematica platform.

The unwrapped webMathematica code and the translated HTML code will be combined together to generate the final webMathematica files.

The unwrapping and the final export are also done by the Mathematica platform.

This whole translation procedure is hidden from the user. From user's point of view, all the translation works are done naturally and finished in one button press.

### <Correctness Checking for the Translation Result>

There is an internal structure that conforms to the logical structure described by webMathematica schema. After the transformation, the generated webMathematica codes are checked to see the correctness of syntaxes and the integrity of the files. This checking module is defined according to the internal tree structure.

<Compare with the Current Technology>

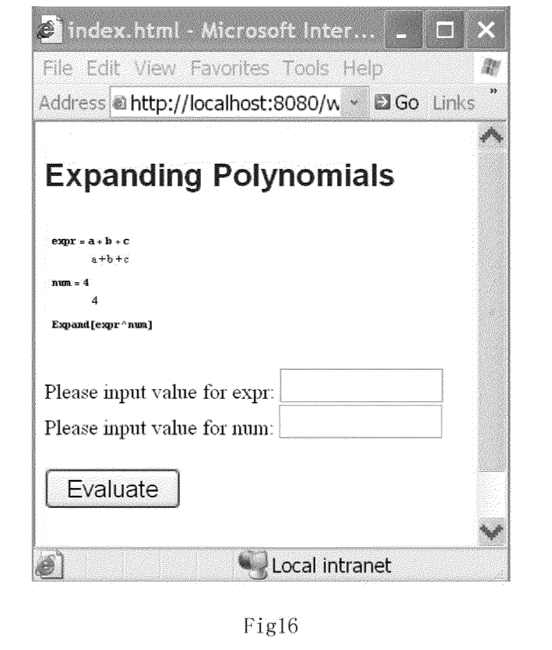

FIG. 15 compares the formats of notebooks translated by the translator (left) in the invention and by webMathematica Author in prior art.

Both files will generate the same webMathematica file, which produces the web page as shown in FIG. 16.

It is noted that webMathematica Author creates notebooks with mixed syntax, whereas the format of translator in the invention contains only tag-annotated Mathematica code. To edit notebooks with webMathematica Author, the users must type in some MSP/JSP codes by themselves, and are responsible of the MSP codes' correctness. By contrast, the users of the translator in the invention only need to use the palette buttons to figure out the types of the cells and cell contents, and need not care about JSP&MSP code. They even need not know anything about webMathematica. As long as they use the buttons to tag the Mathematica file correctly according to the button using rules in different case, they can get correct JSP&MSP file after translation which is launched only by one press of the palette button “Export”. They can get great relief from avoiding learning JSP\&MSP or typing in JSP\&MSP code by themselves. Also, the layout of the webMathematica web page got after the translation is very similar to the source Mathematica notebook in titles, colors, fonts, indents, and computation forms.

The advantageous of the translator in the invention is that it does not need any hand programming and is very convenient to use.

The translator in the invention can do translation for both static and dynamic computing part of Mathematica notebook. The work in the invention is mainly focus on the translation of dynamic part. The functionalities in the invention have done for the dynamic processing tasks are 3D graphic with optional plotting parameters, 2D graphic with optional plotting parameters, the computing of an customization enabled combination of functions, expressions, variables which are all optional, the import of outside application packages, the hidden function for some content in the source Mathematica notebook that the user does not want the browser user to see on the translated web page returned by browser while only wants the computation result shown there.

It is noted that, the above embodiment is a demonstration but not limitation of the invention. The skilled person in the art can design more substitutive embodiments without beyond the scope of the attached claims.

### Claims

1. A method for transforming source documents which are interactive and organized in a hierarchy of nested cells to web pages, including:

directly mapping the elements of static cells in source documents to web pages so as to enable the transformation of the elements of static cells in source documents to web page elements;

selecting the dynamic cells which are to be transformed from the source documents;

adding the cell level tags or comments for the selected dynamic cells, and then adding the cell element level tags or comments for the selected dynamic cells, so as to construct a one-to-one mapping relationship between the elements of dynamic cells and the corresponding elements of web pages; and

transforming the elements of dynamic cells to corresponding elements of web pages according to the constructed mapping relationship.
2. The method according to claim 1, wherein adding tags or comments of cell element level to said dynamic cells includes: adding one or more tags or comments before or after the content of said dynamic cells, and copying the selected elements of the said dynamic cells in the tags or comments.

What is claimed is:

1. A method for transforming source documents which are interactive and organized in a hierarchy of nested cells to web pages, including:
directly mapping the elements of static cells in source documents to web pages so as to enable the transformation of the elements of static cells in source documents to web page elements;
selecting the dynamic cells which are to be transformed from the source documents;
adding the cell level tags or comments for the selected dynamic cells, and then adding the cell element level tags or comments for the selected dynamic cells, so as to construct a one-to-one mapping relationship between the elements of dynamic cells and the corresponding elements of web pages; and
transforming the elements of dynamic cells to corresponding elements of web pages according to the constructed mapping relationship.

2. The method according to claim 1, wherein adding tags or comments of cell element level to said dynamic cells includes: adding one or more tags or comments before or after the content of said dynamic cells, and copying the selected elements of the said dynamic cells in the tags or comments.

3. The method according to claim 2, wherein adding tags or comments of the dynamic cell level before or after the tags or comments a part of which copied the elements of dynamic cells in order to differentiate the type of the dynamic cells, and
wherein the tags or comments of cell level for the dynamic cells include: tags or comments of the dynamic cells for 3D graphic, tags or comments of the dynamic cells for 2D graphic, tags or comments of the dynamic cells for the value replacement, tags or comments of the dynamic cells for evaluation.

4. The method according to claim 1, wherein the dynamic cell element level tags or comments is composed of field representing the type of the elements in the selected dynamic cells, the field representing the content of the elements in the selected dynamic cells, and the segmentation string between the fields; and
wherein the cell element level tags or comments of the dynamic cells are made up of two fields or more fields which are segmented by the segmentation strings.

5. The method according to claim 1, wherein the cell element level tags or comments of the dynamic cells include: tags or comments for the selected expressions, tags or comments for the selected variables, tags or comments for the selected function names, tags or comments for the selected options, tags or comments for the selected inputs, and so on; and
wherein one segmented field segmented by the segmentation string represents that the selected element in the dynamic cell is expression type, and the other segmented field represents the content of the expression element in the selected dynamic cell elements in the tags or comments for the selected expression.

6. The method according to claim 1, wherein the needed dynamic cell element level tags or comments for the processing of dynamic cells in computing type include some or all of the following tags or comments: the tags or comments for the selected functions, the tags or comments for the selected expression, the tags or comments for the selected variables;
wherein the needed dynamic cell element level tags or comments for the processing of dynamic cells in 2D graphic type include some or all of the following tags or comments:
the tags or comments for the selected expression, the tags or comments for the selected variables, the tags or comments for the selected options;
wherein the needed dynamic cell element level tags for the processing of dynamic cells in 3D graphic type include some or all of the following tags or comments: the tags or comments for the selected expression, the tags or comments for the selected variables, the tags or comments for the selected options; and
wherein the needed dynamic cell element level tags or comments for the processing of dynamic cells in value replacement type include some or all of the following tags or comments: the tags or comments for the selected inputs.

7. The method according to claim 1, wherein the steps in the transformation of the elements of the dynamic cells to the corresponding elements in the web pages includes:
calling the pattern matching functions to detect the cell level tags or comments and the cell element level tags or comments of the dynamic cells, and calling the corresponding pattern processing functions to transform the elements of the dynamic cells to the corresponding elements of web pages according to the detected vary combination pattern of the tags or comments.

8. The method according to claim 7, wherein the steps of calling pattern matching functions to detect the tags or comments of dynamic cells include:
finding the field representing the type of the dynamic cells by the detection of the cell level tags or comments;
finding the field representing the type of the copied element and the field representing the content of the element by detecting the cell element level tags and comments;
extracting the elements of the dynamic cell in the source document and the type information of the elements from the field representing the type of the dynamic cells and the fields representing the type and content of the copied elements in the cell level tags or comments and cell element level tags or comments; and
calling the corresponding mode processing functions to perform the transformation and translations to the dynamic cells.

9. A method for transforming Mathematica notebook source document to webMathematica pages, including:
that the translator directly map the elements of the static cells in the source documents to the elements of the targeted web pages according to the one-to-one mapping relationship between the static elements in the source documents and the elements in the web pages; selecting a dynamic cell which is to be transformed from the source Mathematica Notebook; adding cell level tags for the type of the selected dynamic cell by the selection on the control panel of the translator;
for the dynamic cells that need to be processed at the cell element level, add the cell element level tags by the control panel to construct the mapping relationship between the elements of the dynamic cells and the corresponding elements of the web pages, in which Adding cell element level tags to the dynamic cells includes: adding a tag before or after the content of said dynamic cell and copying the selected cell element of the dynamic cell in the tag; and
the translator transforming the elements of the dynamic cells to corresponding elements of targeted web pages by calling the transformation functions matched with the patterns according to the vary combinations of the cell level tags and the cell element level tags.

10. The method according to claim 9, wherein the steps of transformation of elements in the dynamic cells to the targeted web page elements include: the translator searching for the matched transformation functions by calling the pattern matching function to detect the cell level tags and the cell element level tags of the dynamic cell, then using the found matched transformation functions to transform the elements of the dynamic cells to the corresponding elements of targeted web pages.

11. A method for constructing the overall mapping relationship between the elements of source documents which are interactive and organized in a hierarchy of nested cells and the elements of targeted web pages, including:
constructing the definite mapping relationship between every element in static cells of source documents and every corresponding element in targeted web pages in the area of mapping table;
selecting the dynamic cells that need to be mapped from the source documents;
adding the cell level tags which represent the cell type information to the selected dynamic cells, then adding the cell element level tags to the selected dynamic cells, wherein the cell element level tags include the copy of the selected element of the dynamic cell;
constructing the area which is related with the cell level tags in the mapping table, then constructing the definite mapping relationship between the every element copy in the cell element level tags and every corresponding element in the targeted web pages in the area, so as to construct the definite mapping relationship between every element of dynamic cells and every corresponding element of targeted web pages.

12. The method according to claim 11, wherein the construction of definite mapping relationship is realized by writing the static cell element and dynamic cell elements as original in the mapping table.

13. The method according to claim 11, wherein the source document is Mathematica notebook document, and the targeted web page is webMathematica files.
